(19) United States
(12) Patent Application Publication
(10) Pub. No.: US 2019/0190329 A1
(43) Pub. Date: Jun. 20, 2019

(54) ROTOR OF ROTARY ELECTRIC MACHINE

(71) Applicant: HIWIN MIKROSYSTEM CORP., Taichung City (TW)

(72) Inventors: Cheng-Xun PAN, Taichung City (TW); Huang-Ming LIN, Taichung City (TW); Ming-Chi LAI, Taichung City (TW); Chia-Hsiang LIEN, Taichung City (TW)

(21) Appl. No.: 15/847,027

(22) Filed: Dec. 19, 2017

(51) Int. Cl. H02K 1/27

(52) U.S. Cl. CPC H02K 1/27

(57) ABSTRACT

A rotor of the rotary electric machine comprising a ring, a plurality of magnetic pole portions, a plurality of slots and a plurality of magnets is provided. Each magnetic pole portion comprises two magnetic portions with an angle (C) between 20° ^{˜}90°. The slots are configured between the magnetic pole portions to hold the magnets. Therefore, the magnetic field of the rotor is concentrated and the iron loss of the rotor is decreased.

### BACKGROUND OF THE INVENTION

### Field of the Invention

The invention relates to a rotary electric machine, and more particularly to a rotor of the rotary electric machine.

### Description of the Related Art

Recently, the rotary motor adopts the embedded magnet technology to fix the permanent magnet within the rotor to prevent from magnet loosening and demagnetization. However, the magnetic flux leakage is found in the embedded magnet structure such that the researchers focus on improving this problem.

With respect to the conventional patents concerning to improve magnetic flux leakage, the EP2201663 discloses two irregular pentagonal spaces arranged on one end of each magnet slot, the JP3425176 discloses two triangular spaces arranged on one end of each magnet slot, and the JP5954279 discloses a rotor with multiple planar edges corresponding to the magnet slots respectively.

Although the above mentioned technologies can improve magnetic flux leakage, the limited effect still needed to be developed.

### SUMMARY OF THE INVENTION

In view of the disadvantages of prior art, the object of the present invention is to provide a rotor of the rotary electric machine to decrease the iron loss and the torque.

To achieve the above object, the present invention provides a rotor of the rotary electric machine comprising a ring, a plurality of magnetic pole portions, a plurality of slots and a plurality of magnets. Each magnetic pole portion comprises two magnetic portions with an angle (C) between 20° ^{˜}90°. The slots are configured between the magnetic pole portions to hold the magnets.

In one embodiment of the present invention, the ring comprises a plurality of supports radially configured on the ring.

In one embodiment of the present invention, each of the magnetic pole portions comprises two protrusions opposite with each other and extended toward the slots.

In one embodiment of the present invention, each of the magnets comprises a first width (W1), and each of the magnetic pole portions comprises a second width (W2); the first width (W1) and the second width (W2) fulfill with the following equation:

$$\frac{W 1}{4} \leq W 2 \leq \frac{W 1}{2}$$

In one embodiment of the present invention, each of the magnets comprises a first width (W1) and each of the magnetic pole portions comprises a third width (W3) wherein the third width (W3) is larger than the first width (W1).

In one embodiment of the present invention, each of the magnets comprises a first length (L1), and each of the magnetic pole portions comprises a connection portion with a second length (L2) wherein the first length (L1), the second length (L2) and the angle (C) fulfill with the following equation:

0.5L1×cos(C)≤L2

In one embodiment of the present invention, the angle (C) is 25°, 50° or 80°.

Accordingly, the rotor of the rotary electric machine provides the angle (C) defined between 20° ^{˜}90° to concentrate the magnetic field of the rotor and decrease the iron loss of the rotor. The relation between the first width W1 of the magnet 40 and the second width W2 of the connection portion 25 is modified to decrease the torque. The relation between the first length L1 of the magnet 40 and the second length L2 of the connection portion 25 is predetermined to raise the flux linkage and decrease the iron loss of the rotor.

### BRIEF DESCRIPTION OF THE DRAWINGS

FIG. 1 is a schematic view of the rotor of the rotary electric machine according to the first embodiment of the present invention;

FIG. 2 is an exploded view of the rotor of the rotary electric machine according to the first embodiment of the present invention;

FIG. 3 is a cross sectional view of the rotor of the rotary electric machine along the line 3-3 of FIG. 1;

FIG. 4 is a partial plan view of the rotor of the rotary electric machine according to the first embodiment of the present invention;

FIG. 5 is a partial plan view of the rotor of the rotary electric machine according to the second embodiment of the present invention;

FIG. 6 is a partial plan view of the rotor of the rotary electric machine according to the third embodiment of the present invention;

FIG. 7 is a chart illustrating the relation between the angle and the torque of the present invention; and

FIG. 8 is a chart illustrating the relation between the second width W2 and the torque.

### DETAILED DESCRIPTION OF THE PREFERRED EMBODIMENTS

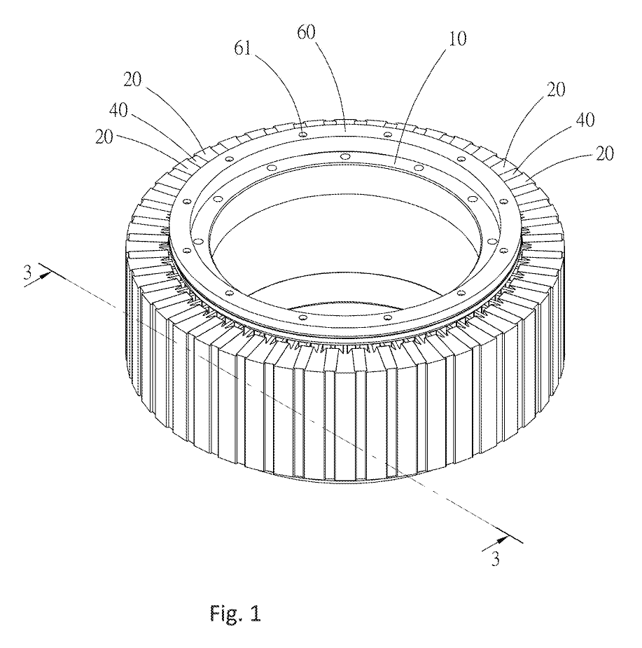

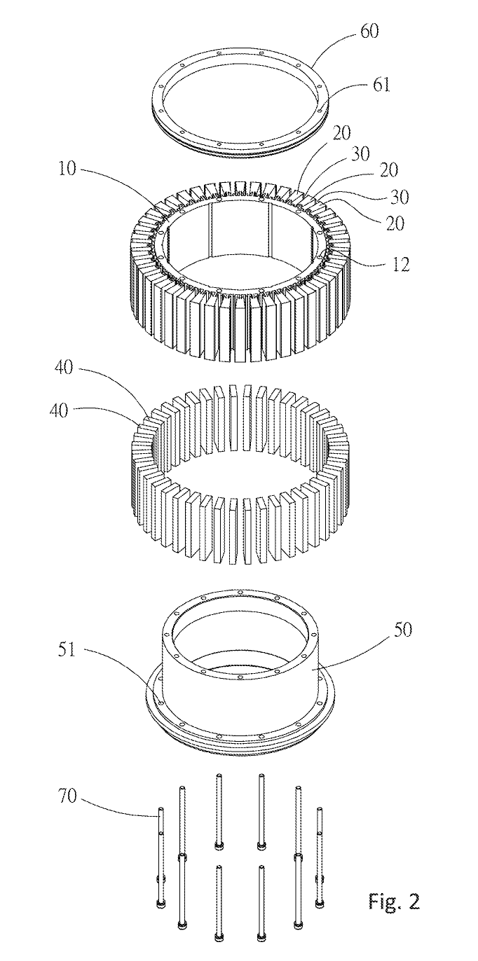

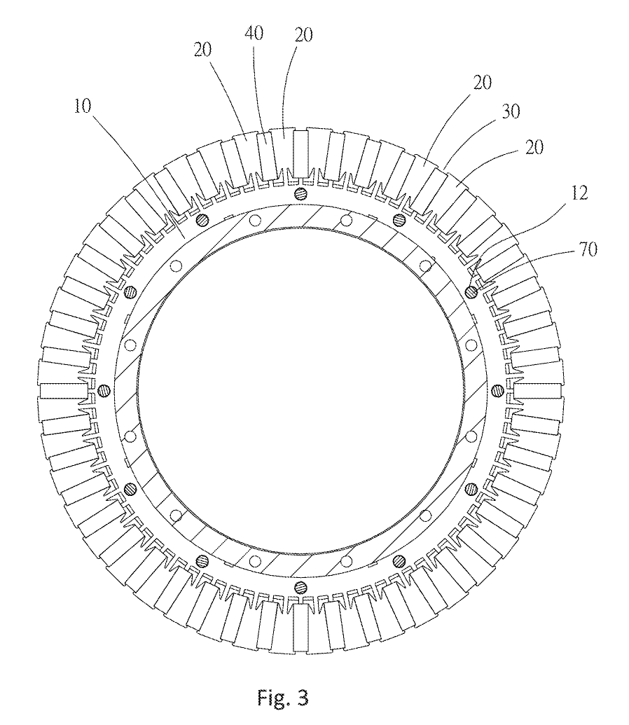

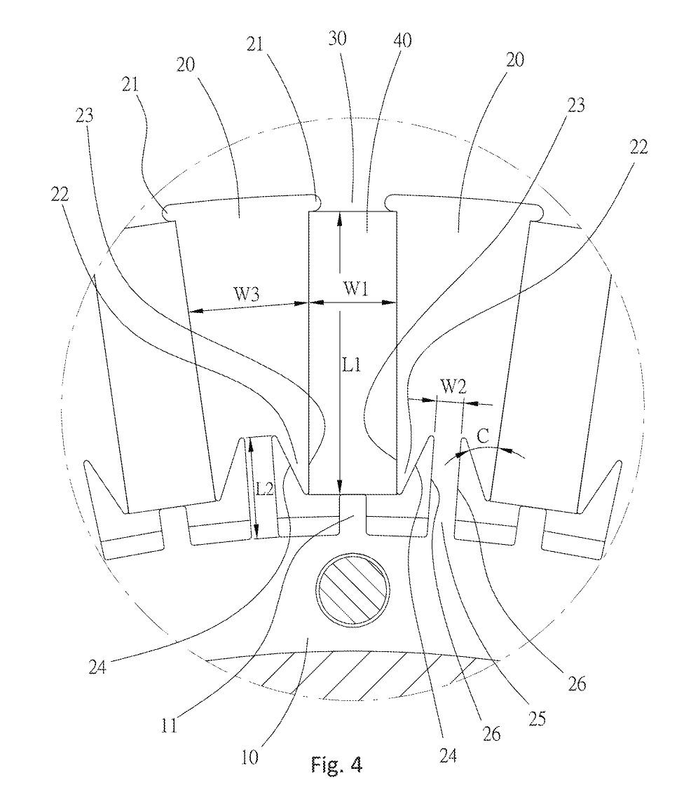

Refer to FIG. 1 to FIG. 4 which illustrate the rotor of the rotary electric machine according to the first embodiment of the present invention. The rotor of the rotary electric machine includes a ring 10, a plurality of magnetic pole portions 20, a plurality of slots 30, a plurality of magnets 40, a fixture 50, a disc 60 and a plurality of connecting units 70.

The magnetic pole portions 20 are positioned on the ring 10 radially wherein the slots 30 are configured between the magnetic pole portions 20. The ring 10 includes a plurality of supports 11 radially extruded on the ring 10 wherein the supports 11 are configured between the magnetic pole portions 20 and corresponds to the slots 30. Besides, each magnetic pole portion 20 includes two protrusions 21 opposite with each other and extended toward the slots 30 to provide two protrusions within each slot 30. The magnets 40 are held within the slots 30 through the supports 11 extruded on the ring 10 and the protrusions 21 extended toward the slots 30.

The fixture 50 is located at one end of the rotor and partially within the rotor. The disc 60 is set against the other end of the rotor. The fixture 50 includes a plurality of first linking holes 51, and the disc 60 includes a plurality of second linking holes 61 wherein the first linking holes 51 and the second linking holes 61 correspond to the through holes 12 of the ring 10. The connecting units 70 are secured within the first linking holes 51, the through holes 12 and the second linking holes 61 to fasten the rotor between the fixture 50 and the disc 60 for assembly. In this embodiment, the connecting units 70 are bolts. In other embodiment, the connecting units 70 are screws and the first linking holes 51, the through holes 12 and the second linking holes 61 are screw holes to provide another design selection.

Specifically, each magnetic pole portion 20 comprises two magnetic portions 22 adjacent to the ring 10. Each magnetic portion 22 comprises a lateral side 23 and an inclined side 24 wherein an angle C is provided between the lateral side 23 and the inclined side 24. In this embodiment, the angle C is 25°. With the angle C of the magnetic portion 22, the magnetic field of the rotor is concentrated and the flux linkage is raised to decrease the iron loss of the rotor.

Moreover, each magnet 40 includes a first width W1 defined by two corresponding lateral sides 23 of contiguous magnetic pole portions 20. Each magnetic pole portion 20 includes a connection portion 25 connected with the ring 10 wherein each connection portion 25 includes two edges defining a second width W2. The first width W1 and the second width W2 fulfill with the following equation:

$$\frac{W 1}{4} \leq W 2 \leq \frac{W 1}{2}$$

Each magnetic pole portion 20 includes a third width W3 defined by two lateral sides 23 of each magnetic pole portion 20 wherein the third width W3 of each magnetic pole portion 20 is larger than the first width W1 of each magnet 40.

Each magnet 40 includes a first length L1, and each connection portion 25 of each magnetic pole portion 20 includes a second length L2 wherein the first length L1, the second length L2 and the angle C fulfill with the following equation:

0.5L1×cos(C)≤L2

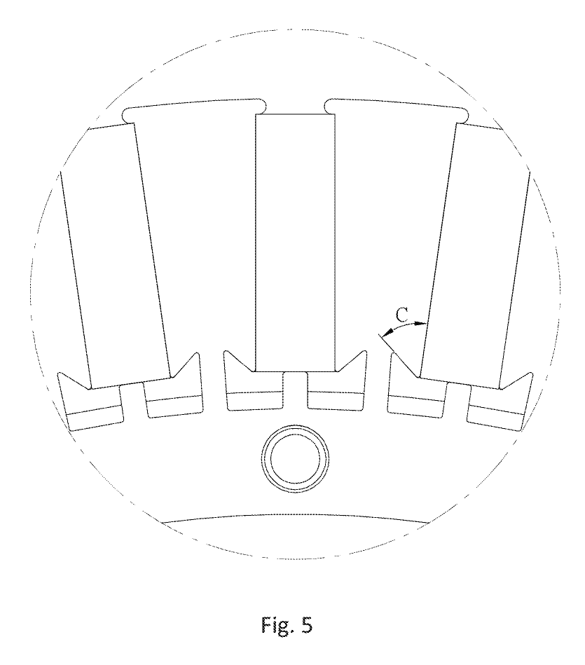

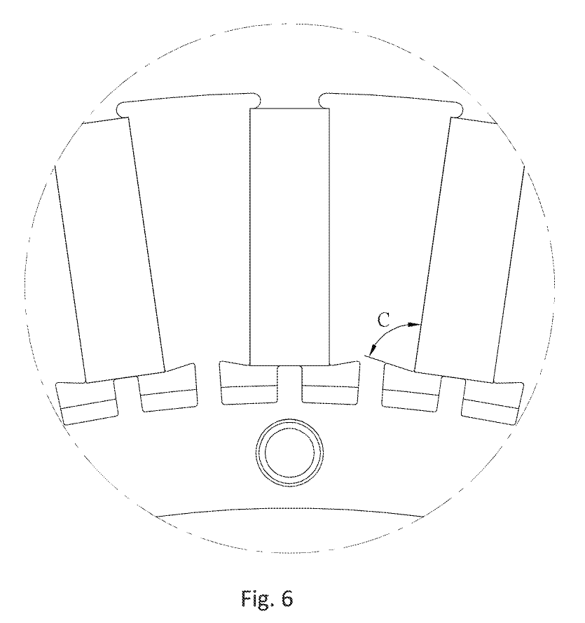

In this embodiment, the angle C is 25°. In other embodiment, the angle C can be defined between 20°^{˜}90°, such as the angle C of 50° shown in FIG. 5 and the angle C of 80° shown in FIG. 6.

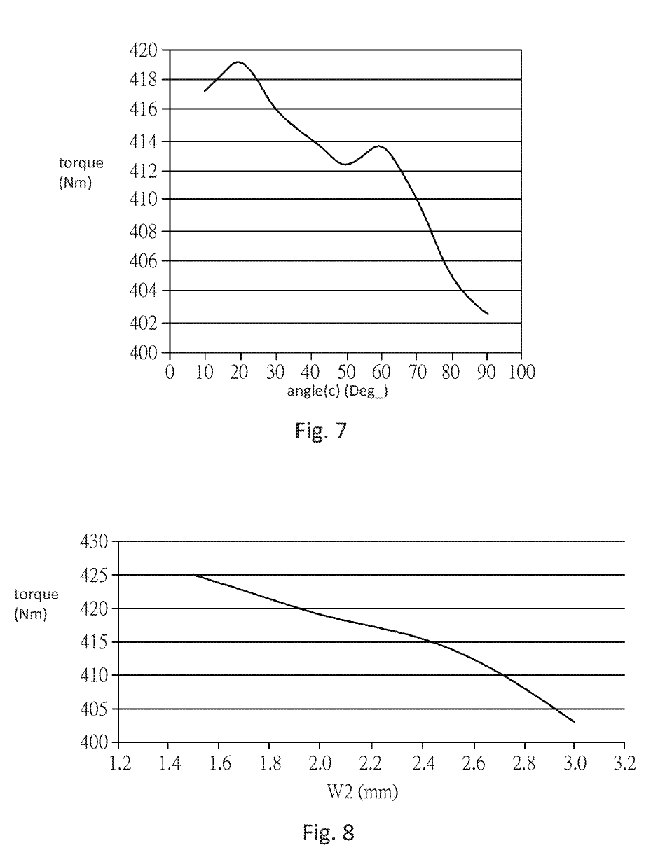

Refer to FIG. 7 showing the chart which illustrates the relation between the angle C of the magnetic portion 22 and the torque wherein the X axis shows the degree of the angle C and the Y axis shows the value of the torque. The chart reveals that the torque decreases as the rise of the angle C.

Refer to FIG. 8 showing the chart which illustrates the relation between the second width W2 of the connection portion 25 and the torque wherein the X axis shows the distance of the second W2 and the Y axis shows the value of the torque. The chart reveals that the torque decreases as the rise of the second W2.

Therefore, the rotor of the rotary electric machine of the present invention provides the magnetic pole portions 20 with magnetic portions 22 wherein each magnetic portion 22 comprises an angle C defined by the lateral side 23 and the inclined side 24 and between 20° ^{˜}90° to concentrate the magnetic field of the rotor and decrease the iron loss of the rotor. In addition, each magnetic pole portion 20 includes a connection portion 25 with the second width W2 thereby modifying the relation between the first width W1 of the magnet 40 and the second width W2 of the connection portion 25 to decrease the torque. Furthermore, the relation between the first length L1 of the magnet 40 and the second length L2 of the connection portion 25 is predetermined to raise the flux linkage and decrease the iron loss of the rotor.

What is claimed is:

1. A rotor of the rotary electric machine, comprising:
a ring;
a plurality of magnetic pole portions, wherein each of the magnetic pole portions comprises two magnetic portions, and each of the magnetic portions comprises an angle (C) between 20° ^{˜}90°;
a plurality of slots, configured between the magnetic pole portions; and
a plurality of magnets, held within the slots.

2. The rotor of the rotary electric machine as claimed in claim 1, wherein the ring comprises a plurality of supports radially configured on the ring.

3. The rotor of the rotary electric machine as claimed in claim 1, wherein each of the magnetic pole portions comprises two protrusions opposite with each other and extended toward the slots.

4. The rotor of the rotary electric machine as claimed in claim 1, wherein each of the magnets comprises a first width (W1), and each of the magnetic pole portions comprises a second width (W2); the first width (W1) and the second width (W2) fulfill with the following equation:
$$\frac{W 1}{4} \leq W 2 \leq \frac{W 1}{2} .$$

5. The rotor of the rotary electric machine as claimed in claim 4, wherein each of the magnets comprises a first width (W1), and each of the magnetic pole portions comprises a third width (W3); the third width (W3) is larger than the first width (W1).

6. The rotor of the rotary electric machine as claimed in claim 1, wherein each of the magnets comprises a first length (L1), and each of the magnetic pole portions comprises a connection portion with a second length (L2); the first length (L1), the second length (L2) and the angle (C) fulfill with the following equation:
0.5L1×cos(C)≤L2.

7. The rotor of the rotary electric machine as claimed in claim 1, wherein the angle (C) is 25°.

8. The rotor of the rotary electric machine as claimed in claim 1, wherein the angle (C) is 50°.

9. The rotor of the rotary electric machine as claimed in claim 1, wherein the angle (C) is 80°.
